(19) United States
(12) Patent Application Publication
(10) Pub. No.: US 2006/0120263 A1
(43) Pub. Date: Jun. 8, 2006

(54) Optical recording medium and its information recording method, and recorder

(75) Inventor: Kinji Kayanuma, Tokoyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 10/525,098

(22) PCT Filed: Aug. 12, 2003
(86) PCT No.: PCT/JP03/10244

§ 371 Date: Feb. 17, 2005

(30) Foreign Application Priority Data
Aug. 19, 2002 (JP) 2002-238015

(51) Int. Cl. G11B 7/24

(52) U.S. Cl. 369/275.4

(57) ABSTRACT

An optical disk includes grooves (G) formed concentrically or spirally from an inner periphery to an output periphery of a disk, wherein prepit (1) are formed on the lands (L) each sandwiched between grooves and grooves (G). The prepit forming region (2) is assigned as a region in which a single or a plurality of prepits (1) are formed. Th prepit forming regions (2) have a fixed length 36 or less times the recording channel length along the recording track, and are arranged apart from on another by 300 or more times the recording channel bit length along the recording track. On the prepit forming region (2), a pattern including a long mark or a long space having a length ten or more times the recording channel bit length so that the long mark or long space covers the prepit (1) on the recording track.

### TECHNICAL FIELD

The present invention relates to an optical recording medium, and more particularly, to an optical recording medium having grooves formed concentrically or spirally and prepits formed between and/or on the grooves. The present invention also relates to an information recording method and a recording unit for recording data on such a high-density recording medium.

### BACKGROUND ART

Known examples of recordable optical disks include DVD-R (Digital Versatile Disc-Recordable) and DVD-RW (Digital Versatile Disc-Rewritable). On these recording disks, a recording track is formed with a fine wobble at a specified frequency (140 kHz). Prepits are provided on a land, wherein decoding of a signal detected from the prepit can determine the position on the disk.

FIG. 15 shows arrangement of prepits and wobbles provided on a DVD-R or DVD-RW disk. Grooves are used as recording tracks. The groove is formed so as to wobble at a specified frequency when the disk is rotated at a specified linear speed. For this reason, adjacent recording tracks use misaligned wobble phases. The recording track on the groove is used for data recording in units of eight wobbles per frame. For convenience of the following description, even-numbered frames are represented by F0 and odd-numbered frames are represented by F1. A broken line is used to indicate a boundary between frames. The prepits 15 are formed on the land. In general, the prepit is formed as one or less pit per one cycle of the wobble on a land adjacent to the outer periphery side of frame F0 on a groove. One succeeding prepit may overlap with another prepit formed on the inner periphery of frame F0. In this case, the succeeding prepit is formed on a land adjacent to the outer periphery of frame F1 instead of frame F0. In either case, prepits are formed in first three wobbles of a frame where the recording track has a specified wobble phase.

FIG. 16 shows a format for recording and reproduction. One frame includes therein a 2-byte synchronization pattern (SY) and 91-byte data. Since one byte includes 16 channel bits, one wobble has a cycle of 186 channel bits. The prepits appear at a cycle of 186 channel bits in the case of the shortest interval.

It is known that a high recording density can be realized by using both the land and the groove as recording tracks. This is because of preventing an influence by interference between codes due to data on adjacent tracks. It is possible to create a disk having the same track density by doubling the groove cycle compared to a disk using only the groove as a recording track. This technique is effective for realizing large-capacity disks.

In order to use both the land and the groove on a disk, it is necessary to form physical address information identifiable from both the land and the groove so as not to unfavorably affect reproduction of data on the recording track. When both the land and the groove are used as recording tracks on the above-described DVD-R and DVD-RW disks, data recorded on the land is strongly interfered by prepits also recorded on the land. Thus, correct data reproduction has been difficult.

Grooves are formed on DVD-R and DVD-RW disks so that the wobble frequency of the grooves becomes constant on the entire disk surface. Such disks are subject to gradual misalignment between phases of grooves adjacent to both sides of a land. Consequently, a correct frequency cannot be detected from the recording track on the land.

The wobble arrangement as described in Patent Publication JP-A-2001-250239 can be used to solve the above problem that a correct wobble frequency cannot be detected on the land. JP-A-2001-250239 exemplifies the wobble arrangement such as shown in FIG. 17 so as to avoid interference due to misalignment of wobble phases between recording tracks on the grooves. FIG. 17 shows a partly enlarged zone on an optical recording medium. As shown in FIG. 18, zones are concentrically arranged on an optical recording medium 3. The zones are so formed as to be divided into zone 1 along the innermost periphery to zone N (N is an integer) along the outermost periphery. FIG. 17 shows an example of keeping a constant wobble phase between adjacent tracks in each of the divided zones. This makes it possible to align wobble phases of the adjacent grooves and prevent interference due to the wobble between recording tracks.

Forming groove phases in this manner is also effective for using lands and grooves as recording tracks. Maintaining the constant land width makes it possible to correctly detect a wobble frequency on lands as well as on grooves. Even though wobble phases are aligned on the adjacent tracks, however, it is impossible to solve the first problem of interference between a prepit and data on the recording track. Prepits partially enter the data region on a recording format similar to those used for DVD-R and DVD-RW. Interference from prepits frequently causes data read errors.

On the other hand, there is a method of supplying address information to the recording track in such a manner as to frequency modulate the wobble on CD-R or CD-RW. In this case, the physical address information is recorded on the disk without using prepits to decrease deterioration of the reproduced signal quality due to interference from the physical address information. However, it is difficult to modulate the wobble so as to correctly detect the address information from both the land and the groove. Thus, it is considered that both the land and the groove cannot be used as recording tracks.

### DISCLOSURE OF THE INVENTION

It is an object of the present invention to provide an optical recording medium having address information detectable from both a land and a groove without adversely affecting recording data when both the land and the groove are used as recording tracks, and information recording method and recording unit thereof.

It is to be noted that the present invention relates to a prepit arrangement for using both the land and the groove as recording tracks. This makes it possible to record the address information in a common format between an optical recording medium using both the land and the groove as recording tracks and a medium using either the land or the groove as a recording track, thereby allowing a common recording method to be used therebetween. This common method aims at using a common circuit concerning address identification and format management by the recording unit to ensure high compatibility between both the media. For this reason, the optical recording medium using only the land or the groove also requires arrangement of the address information compliant with the prepit arrangement on the optical recording medium using both the land and the groove.

The present invention provides, in a first aspect thereof, an optical recording medium including: grooves concentrically or spirally arranged from a radially inner periphery toward a radially outer periphery of the medium, lands each disposed between two of the grooves adjacent to each other in a radial direction of the medium, recording tracks each disposed in the groove and/or the land, and a plurality of prepit forming regions disposed in the groove and/or the land and each capable of receiving therein a single or plurality of prepits:

the plurality of prepit forming regions are disposed apart from one another by a distance which is 300 or more times a recording channel bit length:

each of the prepit forming regions having a fixed length which is 36 or less times the recording channel bit length along the groove or land.

The present invention provides, in a second aspect thereof, a method for recording data on the optical recording medium according to the present invention as described above, the method including the step of recording a pattern including a long mark or a long space having ten or more times the channel bit length so that the prepit on the recording track is covered with the long mark or long space on the prepit forming region.

The present invention provides, in a third aspect thereof, a recording unit for recording data on the optical recording medium according to the present invention as described above, the recording unit including: a prepit detecting section for detecting a prepit signal from a signal reproduced from the optical recording medium; a decoding section for decoding the prepit signal to output physical address information; a recording pattern generating section for admixing, based on data to be recorded, a recording pattern including a long mark or a long space having a length ten or more times the channel bit length to the data to be recorded, to generate physical address information; and a recording timing control section for detecting a recorded position based on the physical address information, and controlling timing for start of a recording pattern output from the recording pattern generating section and a channel bit frequency, wherein the recording timing control section controls output timing of the recording pattern so that the long mark or the long space output from the recording pattern generating section covers the prepit.

When the land and the groove are both used as recording tracks, the recording medium and the recording method according to the present invention can correctly detect wobble phases on the land and the groove and form prepits as information containing physical addresses detectable from the land and the groove.

The use of the recording method and the recording unit according to the present invention can protect a prepit forming region with a long mark or a long space. Even a recorded medium enables correct reading of information from a prepit. In addition, it is possible to prevent interference with a reproduced signal from a prepit and prevent a read error from occurring. These effects enable provision of the optical recording medium, the recording method, and the recording unit (or recording/reproducing unit) capable of high-density recording.

As described in preferred embodiments of the present invention, the long space or the long mark can be selected depending on a frame to be recorded. When a multi-layer medium is used, there is provided an effect of avoiding occurrence of an inter-layer crosstalk resulting from locally concentrating long marks or long spaces.

### BRIEF DESCRIPTION OF THE DRAWINGS

FIG. 1 is a top plan view showing the arrangement of prepits and wobbles on an optical recording medium according to a first embodiment of the present invention;

FIG. 2 is a top plan view showing the arrangement of prepits and wobbles at zone boundaries on the optical recording medium according to the first embodiment;

FIG. 3 is a timing chart exemplifying prepits and wobble waveforms detected on a groove and a land of the optical recording medium according to the first embodiment;

FIG. 4 is a diagram exemplifying a prepit recording format;

FIG. 5 is a block diagram showing a recording unit/reproducer having the optical recording medium according to the first embodiment;

FIG. 6 is a diagram exemplifying a data format;

FIG. 7 is a table exemplifying modulated codes;

FIG. 8 is a table exemplifying synchronization patterns;

FIG. 9 is a top plan view showing the arrangement of prepits and wobbles on an optical recording medium according to a second embodiment of the present invention;

FIG. 10 is a top plan view showing the arrangement of prepits and wobbles on an optical recording medium according to a third embodiment of the present invention;

FIG. 11 is a timing chart exemplifying prepits and wobble waveforms detected on a groove and a land of the optical recording medium according to the third embodiment;

FIG. 12 is a top plan view showing the arrangement of prepits and wobbles on an optical recording medium according to a fourth embodiment of the present invention;

FIG. 13 is a timing chart exemplifying prepits and wobble waveforms detected on a groove and a land of the optical recording medium according to the fourth embodiment;

FIG. 14 is a view showing the arrangement of prepits on an optical recording medium according to a fifth embodiment of the present invention;

FIG. 15 is a top plan view showing the arrangement of prepits and wobbles on a conventional optical recording medium;

FIG. 16 is a diagram exemplifying a conventional data format;

FIG. 17 is a top plan view showing second arrangement of prepits and wobbles on a conventional optical recording medium; and

FIG. 18 is a top plan view showing arrangement of zones on an optical disk.

### BEST MODE FOR CARRYING OUT THE INVENTION

Embodiments of the present invention will be described in further detail with reference to the accompanying drawings so as to ascertain the foregoing and other objects, features, and advantages of the present invention.

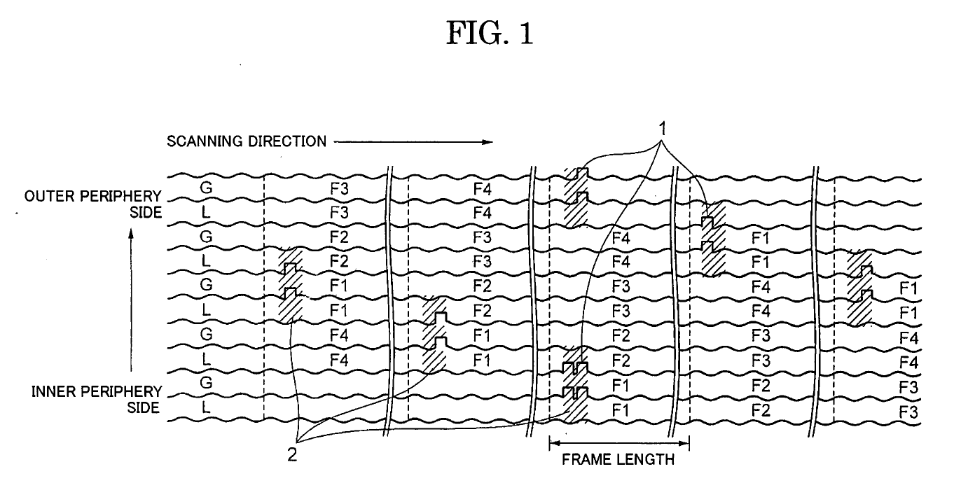

FIG. 1 shows the arrangement of prepits and wobbles formed on an optical recording medium according to a first embodiment of the present invention. Grooves (G) are continuously and spirally formed from the inner periphery to the outer periphery of the disk. The grooves are formed while wobbling at an approximately constant frequency in a radial direction. The grooves disposed adjacent to one another in each zone have the same phase. FIG. 1 is a partially enlarged view of the same zone on the disk formed in this manner. In each zone, the lands (L) each sandwiched between grooves are formed to have a constant track width. For this reason, the following advantages are available. That is, even when the groove and the land are used as recording tracks, an excellent wobble waveform can be detected on both. Reproduced waveforms are hardly subject to an amplitude variation caused by a variation in the recording track width.

On the groove, frames F1, F2, F3, and F4 are periodically arranged along the track in this order. Each zone is configured so that the number of frames per recording track is set to 4K+1 (where K is an integer). Frames F1, F2, F3, and F4 have a length equivalent to an integral multiple of the wobble frequency and are aligned with one another along the radial direction. A prepit forming region 2, which is shown shaded in the drawing, starts at the beginning of frame F1 on the groove and apart from the frame boundary along the recording track by twelve times the channel bit length T. The prepit forming region 2 is twelve times as long as the channel bit length T. The prepit forming region 2 is so wide as to cover three recording tracks including the groove and both adjacent lands. A prepit 1 is provided inside the prepit forming region. The prepit 1 is formed in such a manner that both walls of the groove are shifted approximately half the recording track toward the outer periphery side. Such prepits can be formed by using an exposure beam for prepit formation in addition to a beam for groove exposure during the exposure of a master disk. The exposure beam for prepit formation is radiated at a position shifted approximately half a track toward the outer periphery. That is, the prepit 1 is formed by decreasing the radiation amount of beam for groove exposure at the prepit formation position and by radiating the prepit formation beam toward the outer periphery side. If a prepit is formed to have a length which is four times the channel bit length along the recording track, different patterns can be formed depending on positions corresponding to prepits in the prepit forming region that is divided into three portions. The information including physical addresses is represented by patterns of forming prepits in a plurality of prepit forming regions arranged along the recording track.

A land is assigned with a frame number corresponding to a groove that is adjacent to the land in the direction of the outer periphery side. According to this frame arrangement, the land's frame F1 adjoins the inner periphery side of the groove's frame F1, whereas the land's frame F2 adjoins the outer periphery side of the groove's frame F1. On the groove, any prepit forming region is positioned near the beginning of frame F1. On the land, any prepit forming region is positioned near the beginnings of frames F1 and F2. Along the track direction, the shortest interval of prepit forming regions is measured between the prepit forming region on the land's frame F1 and that on the land's frame F2. Thus, the interval is ensured to be almost equal to the frame length.

An operation to record data on the disk uses a recording format having synchronization patterns including a long mark and a long space in each frame so that the long mark or the long space covers the prepit forming region on the recording track. For this reason, the length of the prepit forming region significantly influences the efficiency of the recording format. The prepit forming region needs to have a minimum length enough to form at most several prepits inside the same. In addition, the cycle of prepit forming regions must be ensured wide enough for the synchronization pattern length. The purpose thereof is to prevent the efficiency of data regions from degrading even when a synchronization pattern including the long mark or the long space is formed on the prepit forming region. In the prepit forming region, it is impossible to correctly obtain signals for the servo circuit used for positioning control of the focusing beam of the optical head. If a prepit forming region is made unnecessarily long, it disorders the positioning control to adversely affect the recording and reproducing performance. In consideration for this, it is necessary to configure the prepit forming region as short as possible and ensure a sufficient interval between them.

At least, the length of the prepit forming region is configured 36 channel bits or less equivalent to the three-byte length according to the (1,7) run-length limited coding. The prepit forming regions are arranged at an interval of 300 channel bits or more equivalent to approximately ten times the length of the prepit forming region. This makes it possible to protect the format efficiency against the presence of prepits. Further, it is possible to prevent prepits from adversely affecting signals for the servo circuit to realize optical disks suitable for high-density recording.

When the prepit forming region is ensured to be longer than 36 channel bits, it is necessary to use a synchronization pattern of four bytes or longer so as to stably form a long mark or a long space on the prepit forming region. Thus, a problem may arise in that addition of the synchronization pattern decreases the format efficiency. It is appropriate to determine the length of the prepit forming region to be up to 36 channel bits equivalent to three bytes. The prepit forming regions may be arranged at an interval of 300 channel bits or more equivalent to approximately ten times the prepit forming region length. This can limit the region of disordering signals for the servo circuit to approximately 10% or less of the entire region. It is desirable to arrange the prepit forming regions at an interval of 300 channel bits or more to prevent the servo characteristics from degrading and ensure the accuracy of the positioning control of the focusing beam by the optical head.

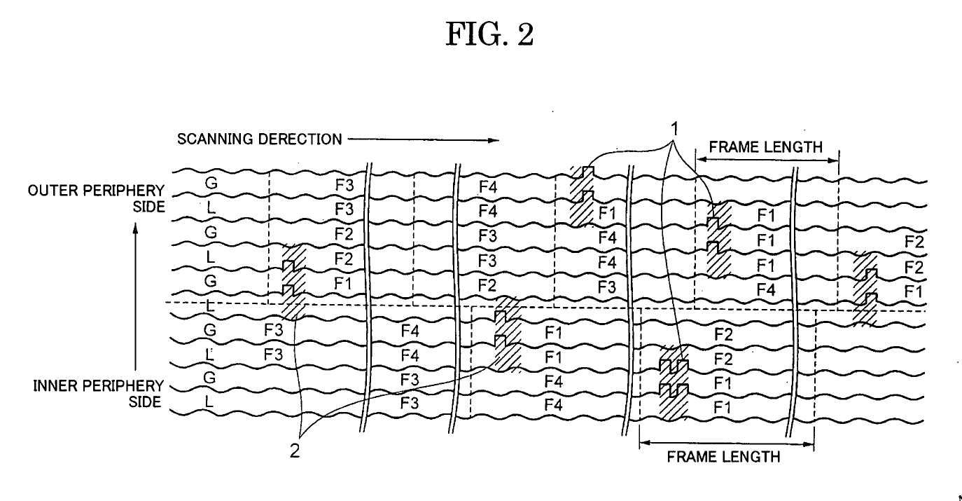

FIG. 2 shows a partially enlarged figure of a zone boundary. In each zone, wobble phases are aligned and frames are arranged in order. Accordingly, frame boundaries are aligned along the radial direction in each zone. On the contrary, wobble phases and frame boundaries are misaligned across the zone boundary. The example depicted in FIG. 2 shows that wobble phases and frame boundaries are misaligned, when a zone boundary exists on the land and wobble cycles are changed stepwise across the zone boundary. Since wobble cycles change across the zone boundary, it is difficult to accurately identify a channel clock. On the zone boundary, prepit forming regions appear irregularly to the inner periphery side and the outer periphery side. It is thus difficult to avoid crosstalk caused by prepits in the recording. For this reason, it is desirable not to use several tracks for data recording or reproduction near the zone boundary.

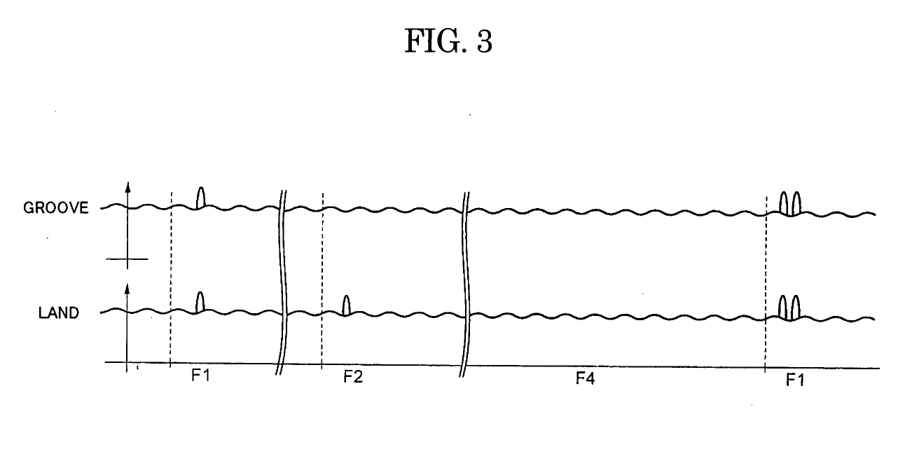

FIG. 3 exemplifies waveforms obtained from wobbles and prepits on the optical recording medium according to the first embodiment. The recording track on the groove shows a prepit only at the beginning of the frame F1. A reproduced waveform from the prepit is obtained as a pulse superposed on the wobble. Assuming that the wobble cycle is 24 times the channel bit length, the information including physical addresses can be demodulated based on the relationship between the prepit detection timing and the wobble phase. It is also assumed here that the prepit forming region is divided into three sections each having a length of 4T and that the presence or absence of prepit is represented as 1 or 0 in each section. When four types of patterns 101, 100, 010, and 001 are used, it is possible to represent one-bit information and a code boundary per four frames. At the beginning of the code, for example, patterns 100 and 101 are allocated to data “0” and “11”, respectively. Otherwise, patterns 010 and 001 are allocated to data “0” and “1”, respectively.

On the land, a prepit detection pulse is obtained at the beginning of frame F1 because the boundary is deformed between the land and the groove adjacent thereto in the direction of the outer periphery side. In addition, a prepit is also detected at the beginning of frame F2 because the boundary is deformed between the land and the groove adjacent to the inner periphery side. No prepit appears in frames F3 and F4. A prepit can be selected for detection only from frame F1 even on the land by using the frame cycle and the fact that no prepit is detected from the preceding frames. In this case, when the physical address information is obtained from the prepit on the land, that information becomes identical to the physical address information on the groove adjacent thereto in the direction of the outer periphery side. A tracking polarity is used to make a distinction between physical addresses for the land and the groove.

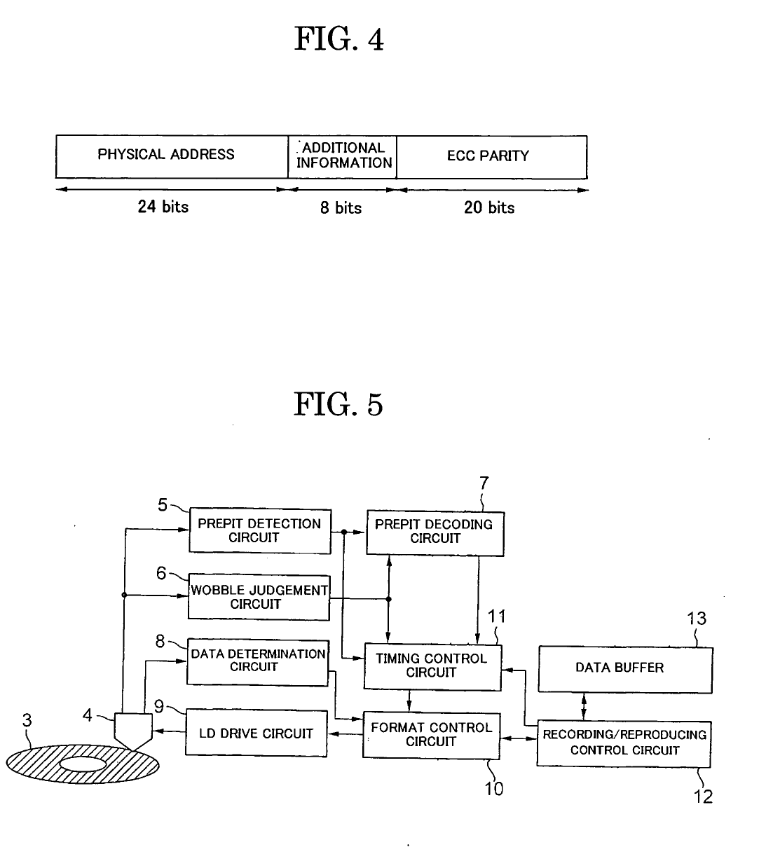

FIG. 4 exemplifies a format to record information including a physical address supplied to a prepit. Since one bit of prepit information is supplied per four frames, 52 bits obtained from 208 frames configures code information. The code information contains a 24-bit physical address, 8-bit additional information, and a 20-bit (5-symbol) ECC parity. The ECC parity is provided to correct a prepit detection error that is divided into five 4-bit symbols. The provision of the ECC parity can correct up to two symbols of a prepit detection error and detect three symbols of a detection error.

The following describes the recording and reproducing method using the optical recording medium according to the first embodiment of the present invention. FIG. 5 exemplifies the configuration of a recording/reproducing unit during recording and reproducing while using the optical recording medium according to the first embodiment. A servo circuit (not shown) controls positions of an optical head 4. The optical head 4 focuses a light beam onto a recording track disposed on the optical recording medium 3 and outputs, from the recording track, the waveform as shown in FIG. 3 that the pulse waveform resulting from the prepit is superposed on the wobble waveform, as a difference signal from a detector (not shown) that is bisected in the direction along the track. In addition, the above-described bisected detector generates a sum signal representing a contrast change resulting from recording pits formed on the recording track. A binary-coding circuit provided in a prepit detection circuit 5 detects the timing of the presence of the prepit to generate a prepit detection pulse. The binary-coding circuit also receives the wobble waveform superposed on a pulse waveform, to output a binary signal synchronized with the wobble.

A prepit decoding circuit 7 decodes information containing a physical address, which is provided to the prepit, based on the prepit detection pulse timing and the number of pulses obtained by the prepit detection circuit and based on the timing of the binary signal of the wobble obtained by the wobble detection circuit, outputting the same. Data is recorded on the optical recording medium as follows. First, a host system (not shown) stores data to be recorded in a data buffer 13. Then, the host system (not shown) specifies a logical address of the data to be recorded to the recording/reproducing control circuit. The recording/reproducing control circuit encodes the data to be recorded based on the specified logical address and performs error correction coding. The recording/reproducing control circuit also calculates a physical address of the data to be recorded based on the logical address and outputs the physical address to the timing control circuit 11. The timing control circuit is supplied with the prepit detection pulse timing from the prepit detection circuit and the binary signal of the wobble from the wobble detection circuit 6. Based on the input pulse timing and binary signal, the timing control circuit synthesizes a recording clock synchronized with a rotational speed of the optical recording medium 3. The timing control circuit uses the physical address information output from the prepit decoding circuit 7, to detect the start position of the physical address for the data to be recorded. When identifying the physical address of the data to be recorded and supplied from the recording/reproducing control circuit, the timing control circuit outputs the recording clock and a recording gate signal to the format control circuit 10. The format control circuit adds a synchronization pattern to the data received from the recording/reproducing control circuit and applies coding modulation to the data. The format control circuit outputs a recording control pulse to an LD drive circuit 9 in synchrony with the recording clock. The optical head 4 then forms a recording pit on the optical recording medium 3.

The timing control circuit detects a phase difference between two timings. One is output timing of a pattern equivalent to the long mark or the long space determined by the recording clock frequency. The other is the timing for the wobble phase or the prepit detection pulse. Continuously providing the frequency control using a phase synchronization loop makes it possible to continue recording so as to form the long mark or the long space on prepits at any time.

Data is reproduced as follows. The optical head 4 reads the signal representing the contrast change from the optical recording medium. Based on this signal, a data determination circuit determines binary data. The format control circuit extracts the synchronization and decodes the data. The host system (not shown) specifies the logical address of data to be reproduced for the recording/reproducing control circuit. Based on this logical address, the recording/reproducing control circuit calculates a physical address and outputs the same to the timing control circuit. The format control circuit specifies the start timing of the reproduced data for the format control circuit based on the physical address obtained from the prepit decoding circuit and a synchronization extraction result from the binary data. The format control circuit extracts the specified timing data and outputs the same to the recording/reproducing control circuit. The recording/reproducing control circuit applies error correction to the input data, stores the reproduced data in the data buffer, and notifies completion of the data reading to the host system (not shown).

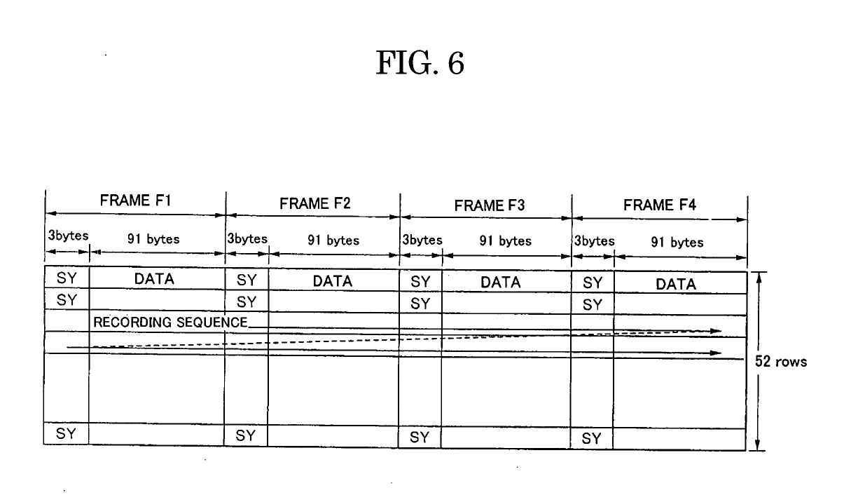

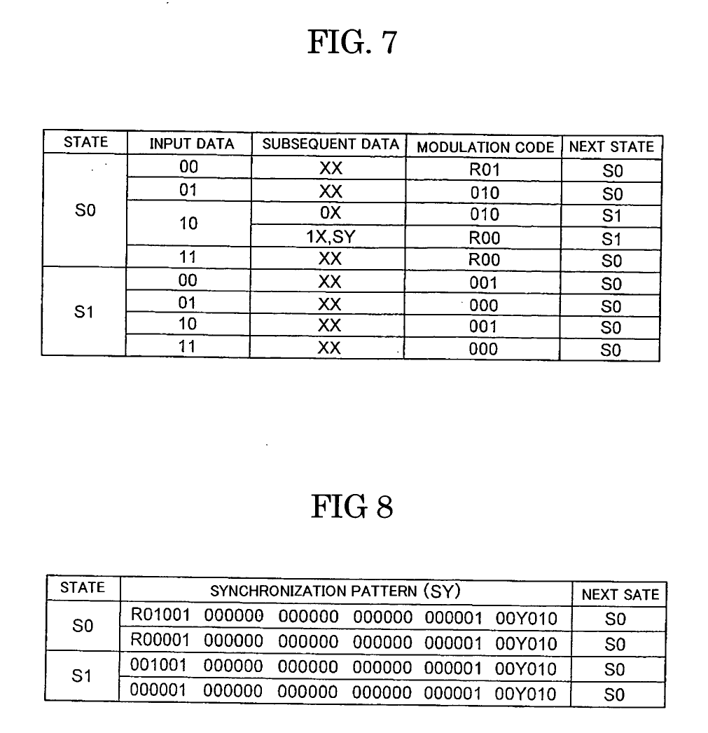

The following describes in more detail the physical format used for recording and reproduction. During recording, the format control circuit adds a synchronization pattern in the format as shown in FIG. 6. One frame includes a 3-byte synchronization pattern SY and 91-byte data containing an error correction parity added by the recording/reproducing control circuit. If the coding modulation provided by the format control circuit uses the NRZI recording based on the (1,7) run-length limited coding at a coding ratio of 2/3 as shown in FIG. 7, one byte equals 12 channel bits and one frame equals 1128 channel bits, thereby having an integral multiple of 24 channel bits of the wobble frequency. The format control circuit contains a (1,7) modulation circuit (not shown) that has two states S0 and S1. The initial state is S0. An internal state, input data, and a succeeding state determine a modulated code to be output and the next state. In the coding table of FIG. 7, the symbol X may denote either “0” or “1”. The symbol R denotes using an inverted version of a bit immediately before the modulated code. Particularly when the current state is S0 and the input data is 10, the modulated code R00 is output to set the next internal state to S1 even when the synchronization pattern (SY) follows.

The synchronization pattern SY can be any of patterns each including 36 channel bits as shown in FIG. 8, for example. The synchronization pattern is also selected depending on the internal state of the (1,7) modulation circuit. After the synchronization pattern is output, the next internal state is changed to S0 at any time. In the table of FIG. 8, the symbol R denotes using an inverted version of a bit in the immediately preceding modulated code. The symbol Y is optional for the purpose of controlling direct current components in the recording/reproduced signal. The table in FIG. 8 provides two types of synchronization patterns for each of states S0 and S1. When the NRZI recording is performed, one of the two types of synchronization patterns contains a mark of 24 channel bit length at the center. The other pattern contains a space of 24 channel bit length. Either of two patterns can be selected independently of input data.

In the case of using an optical recording medium according to the first embodiment of the present invention, the prepit forming region begins at the end of 12 channel bits after the frame boundary and has a length of 12 channel bits. Now, it is assumed here to select a pattern containing a space of 24 channel bit length from the synchronization patterns shown in FIG. 8 and to perform the recording so that the beginning of the synchronization pattern starts from the frame boundary. In this case, the prepit forming region can be contained in the space of 24 channel bit length at any time. There may be a case of using a medium that is subject to degradation in the reflectance by forming a mark. In such a case, it is possible to avoid a decrease in the prepit detection ratio on a recorded disk because the prepit is protected within the long space at any time. The DVD-R and DVD-RW formats allow prepits to exist outside the synchronization pattern. A prepit disorders the reproduced waveform, causing an error during data reproduction. By contrast, the optical recording medium and the recording unit according to the embodiment restrict prepits to exist only inside the long space in the synchronization pattern, thereby significantly reducing the adverse effect on data reproduction.

The prepit forming regions exist only on frames F1 and F2. Frames F1 and F2 may be used to select synchronization patterns containing long spaces. Frames F3 and F4 may be used to select synchronization patterns containing long marks. Since the long mark and the long space are mixed in this manner, it is possible to decrease a crosstalk from adjacent recording layers due to changes in the reflectance or the transmittance even on a medium having multiple recording layers, for example.

The above-described embodiment has presented the example of using the (1,7) run-length limited coding for modulation and configuring the frame with the 3-byte synchronization pattern and the 91-byte data. The modulation code and the frame configuration are not limited thereto and can be selected in accordance with system requirements. For example, it is also possible to use the same 8/16 modulation as used for DVD-R and DVD-RW and use a 2-byte synchronization pattern containing a mark or a space of 14 channel bit length. In addition, any wobble frequencies can be selected except the limitation that a common wobble phase is provided to the recording tracks adjacent to one another in each zone. The embodiment has presented the example where the frame length is an integral multiple of the wobble frequency. For example, four frames may include an integral multiple of wobbles. In this case, no error occurs in the prepit decoding because the F1 frame ensures the relative relationship between the wobble phase and the prepit position.

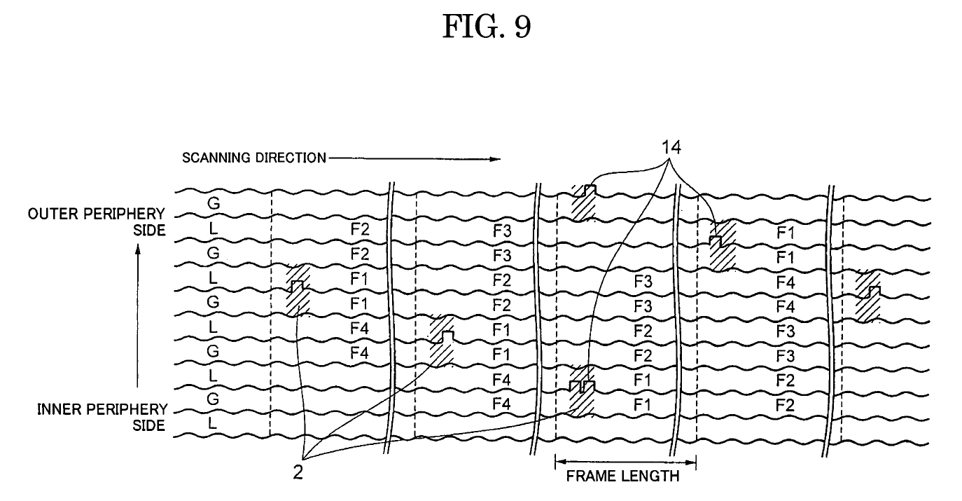

FIG. 9 exemplifies arrangement of prepits and wobbles formed on an optical recording medium according to a second embodiment of the present invention. The embodiment presents an example of deforming only a side wall at the groove's outer periphery side as another example of forming prepits by deforming a groove side wall. Such prepits can be formed during exposure on a master disk by radiating a groove exposure beam and a prepit formation exposure beam only at the position for forming a prepit. The prepit formation exposure beam is radiated to a position deviated approximately half a track toward the outer periphery. When a prepit is formed by deforming the side wall only at the outer periphery side, a prepit forming region exists on a land and a groove sandwiching therebetween the deformed side wall. Frame F2 on the groove or frame F4 on the land is not influenced by deformation of the side wall and has no prepit forming region. Data formatted as shown in FIG. 6 can be recorded on the optical recording medium where prepits are formed as shown in FIG. 9.

Forming prepits as described above decreases the size of a reproduced waveform from a prepit obtained on the groove compared to the deformation of groove's both walls as shown in FIG. 1. A prepit forming region can be formed as wide as one track on the land and the groove, thereby increasing the design choice of the formats. FIG. 9 shows the example of providing the prepit forming region at a cycle of four frames. In this case, there occurs no interference between adjacent prepit forming regions by selecting the number of frames per track so that it differs from a multiple of the cycle of prepit forming region. For example, prepit forming regions can be arranged so as not to adjoin to one another when the number of frames per track is determined to be 3K+1 (K is an integer) and a prepit forming region is provided every third frame. Alternatively, the number of frames per track is determined to be 5K+2 (K is an integer). Frames are numbered as F1, F2, F3, F4, and F5 in units of five frames. Of these frames, prepit forming regions can be provided only on frames F1 and F2. Also in this case, prepit forming regions can be arranged so as not to adjoin to one another. In this manner, it is possible to prevent the long space or the long mark recorded on the prepit forming region from being concentrated on the recording/reproducing beam of the optical head. There is provided an effect of hardly generating an inter-layer crosstalk even on a medium having multiple recording layers.

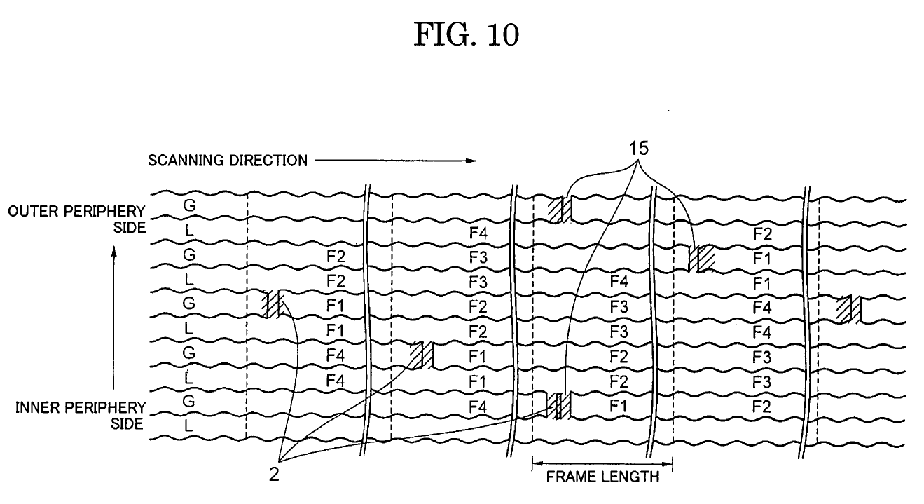

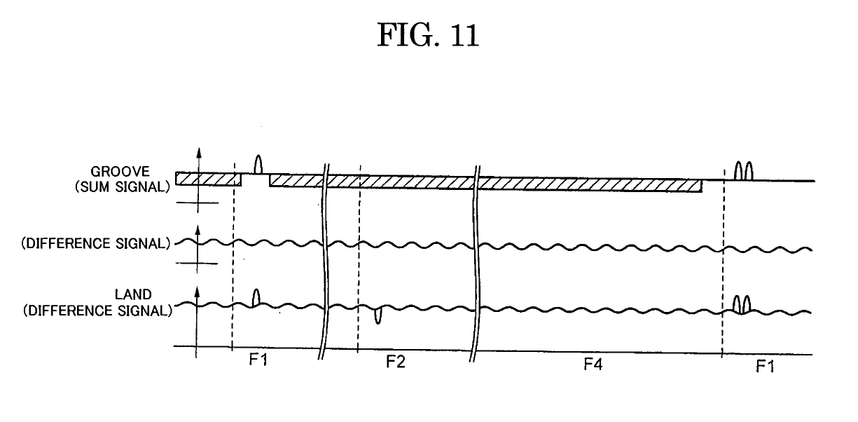

FIG. 10 exemplifies arrangement of prepits and wobbles formed on an optical recording medium according to a third embodiment of the present invention. The example shows formation of prepits by disconnecting the groove. When prepits are formed by disconnecting the groove in this manner, only a groove formation exposure beam can be used to expose a master disk. However, different prepit detection methods must be used for a recording track on the land and a recording track on the groove. FIG. 11 exemplifies waveforms of a sum signal and a difference signal obtained from a bisected detector of the optical head. A recording track on the groove causes a pulse waveform resulting from a prepit to be superposed on the sum signal at the beginning of frame F1 containing the groove disconnection. On the other hand, a wobble waveform appears in the difference signal on which, however, a pulse waveform resulting from a prepit is not superposed. When a mark is formed on the recording medium, the sum signal shows a contrast change as indicated by a shaded portion. There may be a case of recording a synchronization pattern regularly containing the long space on a prepit forming region. In this case, the prepit forming region is not affected by a decrease in the amount of reflected light due to the mark. A prepit detection pulse can be easily obtained simply by supplying the prepit detection circuit with a sum signal output from the optical head and binary-coding the signal according to the amount of reflected light. A recording track on the land causes a pulse waveform resulting from a prepit to be superposed on the difference signal. The pulses have reverse polarities between frame F1 and frame F2. If the prepit detection circuit correctly configures a slice level, the pulse output is only available from frame F1.

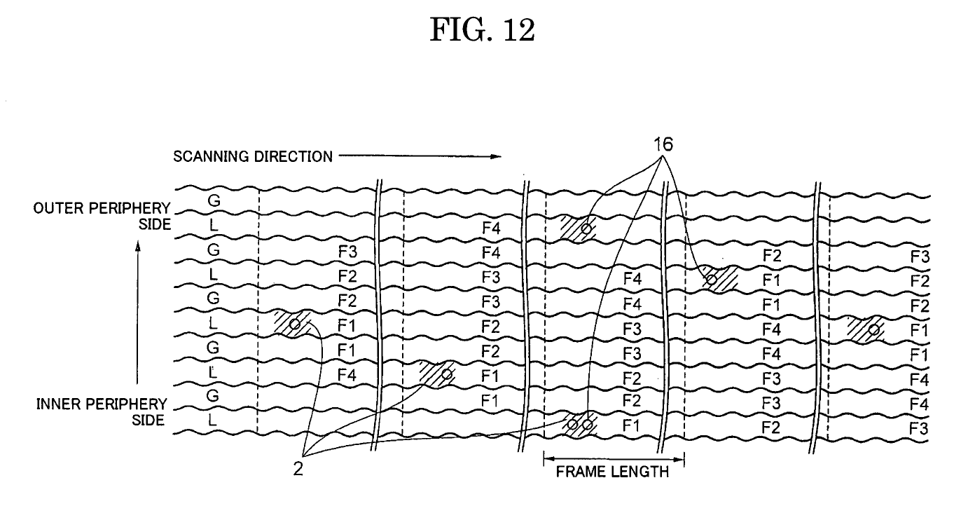

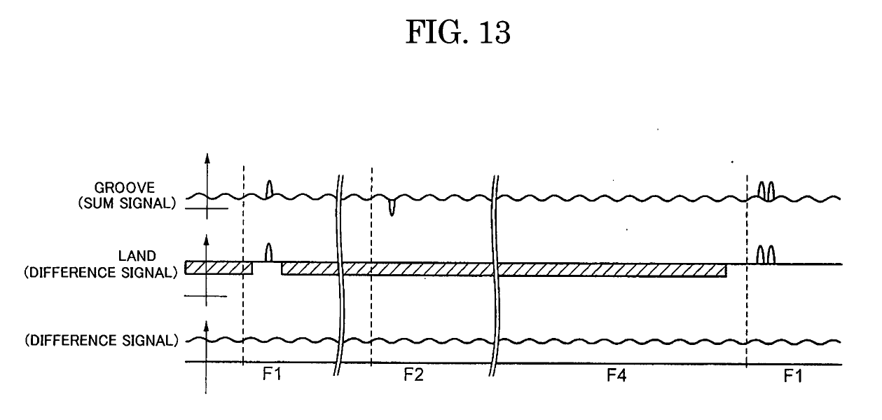

FIG. 12 exemplifies arrangement of prepits and wobbles formed on an optical recording medium according to a fourth embodiment of the present invention. A prepit is formed as an emboss pit in a prepit forming region on the land. FIG. 13 exemplifies waveforms of a sum signal and a difference signal obtained from the bisected detector of the optical head. Also in this case, different prepit detection methods are used for a recording track on the land and a recording track on the groove similarly to reproduced waveforms from the optical recording medium according to the third embodiment. A recording track on the groove causes a pulse waveform resulting from a prepit on the adjacent land to be superposed on the difference signal from the bisected detector of the optical head in frames F1 and F2. The pulses have different polarities between frame F1 and frame F2. If the prepit detection circuit correctly configures a slice level, the pulse output can be obtained solely from frame F1. A recording track on the land causes a pulse waveform resulting from a prepit to be superposed on the sum signal similarly to the recording track on the groove of the optical recording medium according to the third embodiment. Also in this case, it is possible to avoid a prepit detection error due to interference with a recording mark by recording the long mark and the long space in the prepit forming region.

The above-described embodiments have presented the examples of covering the prepit forming region with the long space. However, for example, there may be a case of using a medium that increases a reflectance by forming a mark. In such a case, it may be preferable to regularly cover the prepit forming region with the long mark. It may be optional to record the long mark or the long space on the prepit forming region. The long mark or the long space need not necessarily be contained in a synchronization pattern on a frame where no prepit forming region is available.

The above-described embodiments have presented only the examples of forming one or more prepits within the prepit forming region. Further, it is possible to include a pattern for forming no prepit among the patterns each for forming a prepit in the prepit forming region. For example, it is possible to form one or zero prepit in a single prepit forming region and configure the address information to represent the presence or absence of the prepit. This case also enables a physical address to be decoded based on the continuity thereof. Moreover, adding an odd parity to the prepit at a proper cycle can further reduce the time length to establish the synchronization.

It is a principal object of the present invention to provide an optical recording medium having address information detectable from both a land and a groove without adversely affecting the recording data when both the land and the groove are used as recording tracks. Further, similar prepit arrangement and recording method can be applied to an optical recording medium using only the groove or the land as a recording track.

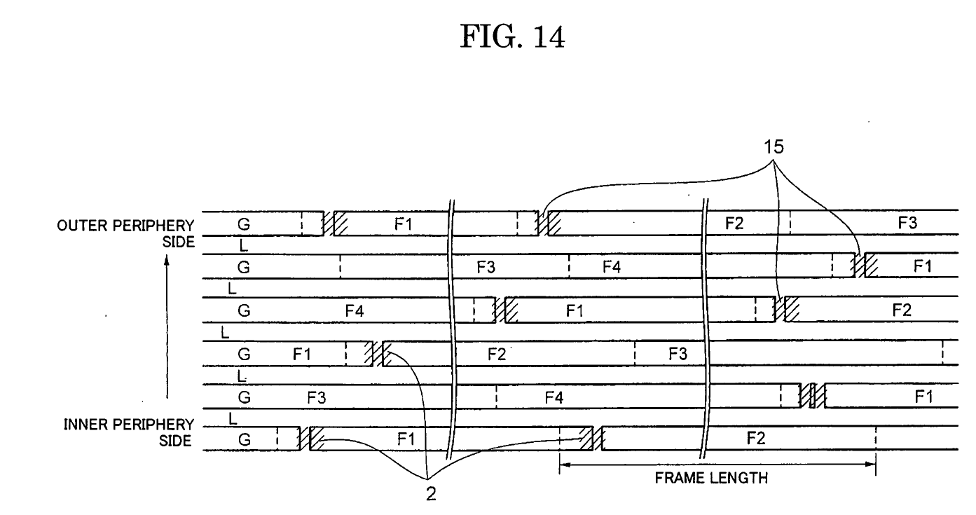

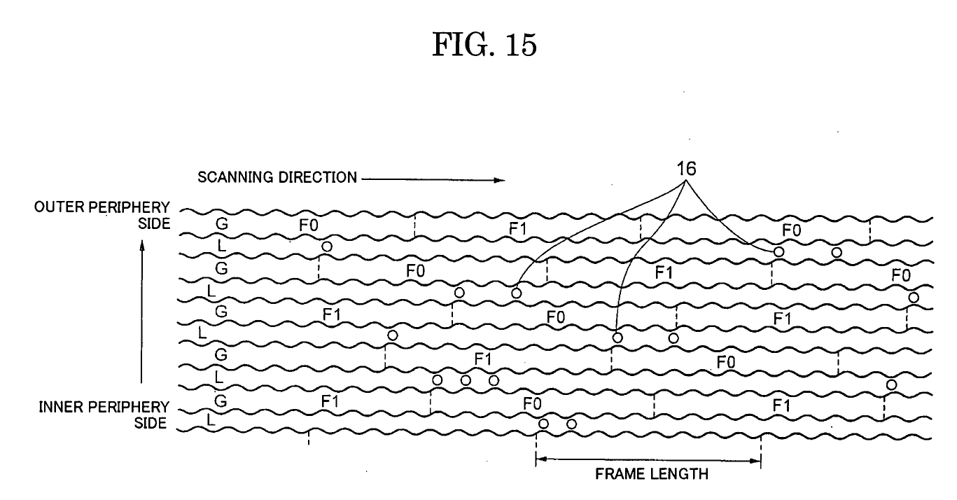

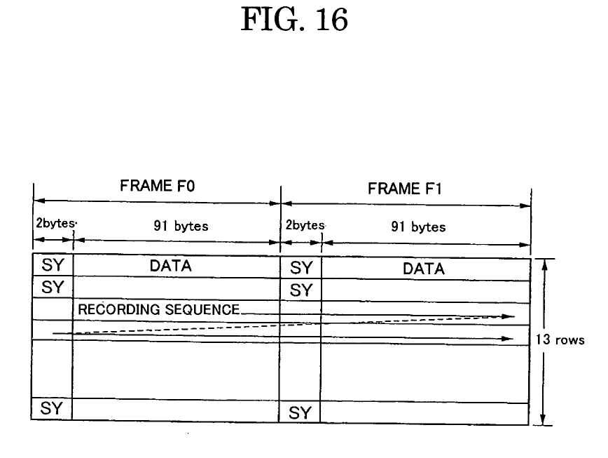

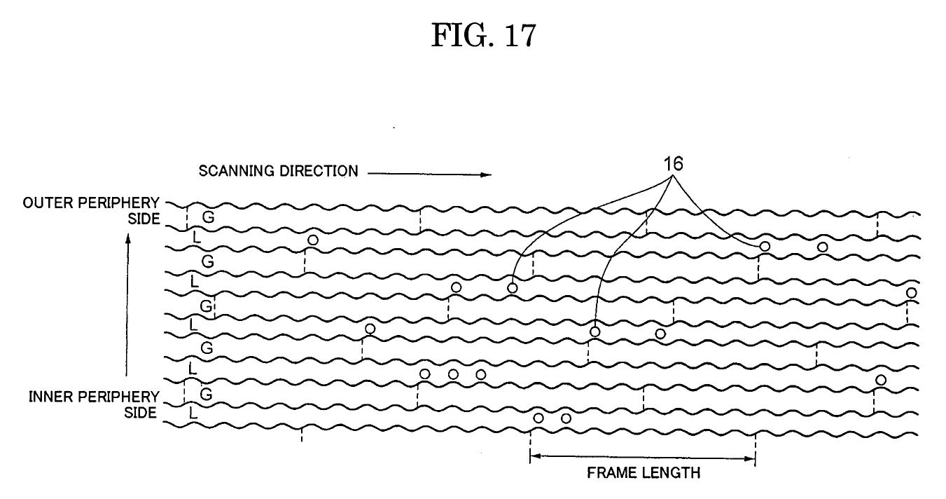

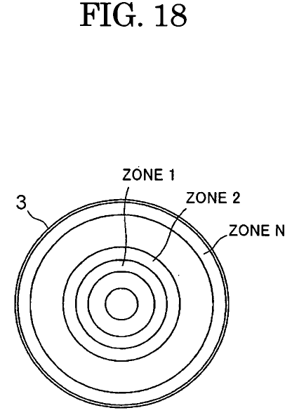

FIG. 14 exemplifies prepit arrangement formed on an optical recording medium according to a fifth embodiment of the present invention. This example uses only the groove as a recording track and provides a prepit as disconnection of the groove. Frames have a boundary as indicated by a broken line and are formed by dividing a recording track provided on the spirally arranged grooves into equal lengths. The frames are not aligned in the radial direction. The grooves may wobble at a specified frequency. FIG. 14 shows the example of using the unwobbled groove. Prepit forming regions are provided only on frames F1 and F2 out of numbered frames F1, F2, F3, and F4 in a cycle of four frames along the recording track. In this case, the prepit detection timing becomes the same as that obtained on the land according to the prepit arrangement described according to the first embodiment of the present invention. Therefore, it is possible to use the same format as shown in FIG. 6.

The example in FIG. 14 uses the recording track having no wobble formed. In this case, the prepit information cannot be decoded based on the relative relationship between the wobble phase and the prepit position. However, the prepit information can be identified by using the periodicity of the prepit forming region, a relative position of a prepit succeeding to frame F1 or frame F2, and a prepit formation pattern. For example, the prepit information can be easily detected by employing a method of limiting the prepit formation pattern to 100 or 101 for the prepit forming region in frame F1.

While there has been described the present invention based on the preferred embodiments, the optical recording medium, and the information recording method and recording unit according to the present invention are not limited to the above-described embodiments. The scope of the present invention also includes various changes and modifications made to the above-described embodiments.

### Industrial Applicability

The optical recording medium according to the present invention can be particularly suitably applied to DVD-R and DVD-RW capable of recording on both the land and the groove.

1. An optical recording medium comprising: a plurality of grooves concentrically or spirally arranged from a radially inner periphery toward a radially outer periphery of the medium, a plurality lands each disposed between two of said grooves adjacent to each other in a radial direction of the medium, a plurality of recording tracks each disposed in said groove and/or said land, and a plurality of prepit forming regions disposed in said groove and/or said land and each capable of receiving therein a single or a plurality of prepits:
said plurality of prepit forming regions are disposed apart from one another by a distance which is 300 or more times a recording channel bit length:
each of said prepit forming regions having a fixed length which is 36 or less times said recording channel bit length along said groove or land, said prepit forming regions having a fixed length which is three or less tracks long along said radial direction and being disposed not adjacent to one another in said radial direction.

2. The optical recording medium according to claim 1, wherein said recording track and said prepit forming region are disposed in each of said groove and said land.

3. The optical recording medium according to claim 1, wherein said medium includes a plurality of zones divided in said radial direction, and said prepit forming regions in each of said zones are arranged, in alignment with one another in said radial direction, at a cycle corresponding to a specified number of recording tracks, along a plurality of lines which divide said medium by an integer in a circumferential direction of said medium.

4. The optical recording medium according to any one of claim 1, wherein said medium includes said plurality of zones divided in said radial direction, and said wobbles are in-phase with one another.

5. The optical recording medium according to any one of claim 1, wherein said prepits in said prepit forming region are formed by deforming groove side walls.

6. The optical recording medium according to any one of claim 1, wherein said prepits in said prepit forming region are formed by disconnection of said grooves.

7. The optical recording medium according to any one of claim 1, wherein said prepit in said prepit forming region is formed as an emboss provided on said land.

8. The optical recording medium according to any one of claim 1, wherein said prepit forming region is provided, in number of one at most for each frame forming a unit of data arranged on said recording track, at a specified position of said each frame

9. The optical recording medium according to claim 8, wherein the number of frames per said recording track is an integer, and said prepit forming regions are intermittently disposed in said frames so that one of two of said recording tracks formed on respective said lands sandwiching therebetween one of said grooves, or formed on respective said grooves sandwiching therebetween one of said lands, includes therein said prepit forming region in one of said frames, whereas the other of said two of said recording tracks includes therein no prepit forming region in said one of said frames.

10. The optical recording medium according to claim 8, wherein said recording track has a wobble cycle equal to 1/n of a frame cycle.

11. The optical recording is according to claim 1, wherein a prepit array including at least one prepit and formed in said prepit forming region is recorded so as to provide part of physical address information or subsidiary information of said medium.

12. The optical recording medium according to claim 4, wherein a single prepit is formed in each said prepit forming region, and is recorded so as to provide part of physical address information or subsidiary information of said medium based on a relative relationship between the wobble phase and the prepit position.

13. A method for recording data on the optical recording medium according to claim 1, said method comprising the step of recording a pattern including a long mark or a long space having ten or more times said channel bit length so that said prepit on said recording track is covered with said long mark or long space on said prepit forming region.

14. A method for recording data on the optical recording medium according to claim 1, said method comprising the step of recording a pattern including a long mark or a long space having ten or more times said channel bit length so that said prepit on one of said recording tracks is covered with said long mark or long space and so that said prepit on another of said recording tracks adjacent to said one of said recording tracks is covered with said long mark or long space.

15. A method for recording data on the optical recording medium according to claim 3, said method comprising the step of covering said prepit on one of said recording tracks with said long mark or long space, and recording a pattern including a long mark or a long space having ten or more times said channel bit length on an area which is aligned with said prepit forming region in said zone and includes therein no prepit forming region.

16. A recording unit for recording data on the optical recording medium according to claim 1, said recording unit comprising:
a prepit detecting section for detecting a prepit signal from a signal reproduced from the optical recording medium;
a decoding section for decoding said prepit signal to output physical address information;
a recording pattern generating section for admixing, based on data to be recorded, a recording pattern including a long mark or a long space having a length ten or more times said channel bit length to said data to be recorded, to generate physical address information; and
a recording timing control section for detecting a recorded position based on said physical address information, and controlling timing for start of a recording pattern output from said recording pattern generating section and a channel bit frequency, wherein said recording timing control section controls output timing of said recording pattern so that said long mark or said long space output from said recording pattern generating section covers said prepit.

17. A recording unit for recording data on the optical recording medium according to claim 1, said recording unit comprising:
a wobble detecting section for detecting a wobble phase from a signal reproduced from the optical recording medium;
a prepit detecting section for detecting a prepit signal from a signal reproduced from said optical recording medium;
a decoding section for decoding said prepit signal to output physical address information;
a recording pattern generating section for admixing, based on data to be recorded, a recording pattern including a long mark or a long space having a length ten or more times said channel bit length to said data to be recorded, to generate physical address information; and
a recording timing control section for detecting a recorded position based on said physical address information, and controlling timing for start of a recording pattern output from said recording pattern generating section and a channel bit frequency, based on said wobble phase output from said prepit detecting section and/or said prepit signal output from said prepit detecting section,
wherein said recording timing control section controls output timing of said recording pattern so that said long mark or said long space output from said recording pattern generating section covers said prepit.
